(19) United States
(12) Patent Application Publication
(10) Pub. No.: US 2007/0050675 A1
(43) Pub. Date: Mar. 1, 2007

(54) [METHOD FOR RESTORING A BOOTED SYSTEM]

(75) Inventor: Sheng-Yi Yu, TAIPEI (TW)

Correspondence Address: MOXA TECHNOLOGIES CO., LTD, P.O. BOX 108-00403, TAIPEI, TW

(73) Assignee: MOXA TECHNOLOGIES CO., LTD., Shing Tien City (TW)

(21) Appl. No.: 11/162,094

(22) Filed: Aug. 29, 2005

(51) Int. Cl. G06F 11/00

(52) U.S. Cl. 714/36

(57) ABSTRACT

A method for restoring a booted system divides a flash memory in a device using an embedded Linux system into four blocks and saves a boot loader, a Linux kernel, a mini root file system and a user root file system of the embedded Linux system separately into each block and sets the block for storing the user root file system as a read/write block, and the rest of the blocks are set as read-only blocks. The mini root file system installs a detect program capable of detecting whether or not the user root file system is damaged, such that when the device is booted, the detect program will detect whether or not the user root file system is damaged first to determine to mount the user root file system or the mini root file system to the embedded Linux system.

### BACKGROUND OF THE INVENTION

1. Field of the Invention

The present invention relates to a method for restoring a booted system, and more particularly, to such a method for a device of an embedded Linux system to boot normally.

2. Description of Related Art

According to the definition of the Institute of Electrical Engineers (IEE), an “embedded System” is a control, monitoring, or accessory equipment, machine, or even a factory-operating device, and the embedded system is integrated with a computer software and hardware that can meet the “Custom-made” principle. In other words, it is a system developed according to a certain specific application. Since the embedded system can enhance the stability and portability of a product, lower the cost, and add specific functions, etc, therefore the embedded systems are extensively used. At present, the common embedded systems include VxWORK, QNX, Palm OS, Windows CE, and Linux, etc, and wherein the embedded Linux system has an advantage of free license, and thus the embedded Linux system is used by most users.

The development of the embedded Linux system requires the following three basic elements: a boot loader, a Linux kernel and a root file system, and the Linux kernel and the root file system are read-only files such as CRAMFS or ROMFS installed into a flash memory for users to boot a system. Since the root file system is a read-only file, users cannot write an application program into the root file system, and thus making some of the application programs unusable. Therefore, related R&D engineers load the root file system into a RAM disk, so that the application program can write in the root file system in the RAM disk. However, the root file system in the RAM disk will be totally erased when the system is turned off, and it is necessary to repeat the foregoing procedure for a use of next time, and such arrangement is very inconvenient.

To solve the foregoing problem, some manufacturers store the Linux kernel and the root file system in separate blocks of a flash memory. Referring to FIG. 1, the prior art flash memory is divided into three blocks, and the boot loader, the Linux kernel and the root file system are stored separately in different blocks, and the two blocks stored with the boot loader and the Linux kernel are set as read-only blocks, and the block stored with the root file system is set as a read/write block, such that the root file system can write in other application programs such as JFFS2, EXT2 and EXT3.

However, such arrangement still has a serious issue. If a power failure occurs while the root file system is writing in a file, the root file system will be damaged and unrepairable. As a result, the system cannot be booted.

### SUMMARY OF THE INVENTION

The present invention has been accomplished under the circumstance in view. It is therefore the main objective of the present invention to use a read-only block and a read/write block of a flash memory of a device to separately store a mini root file system and a user root file system, and install a detect program to the mini root file system, such that when the device is booted, the detect program will be executed first to detect whether or not the user root file system is damaged in order to determine using the mini root file system or the user root file system as the embedded Linux system. The present invention can prevent the device from being unusable due to the damage of the root file system.

### BRIEF DESCRIPTION OF THE DRAWINGS

FIG. 1 is a specification table of a prior art flash memory.

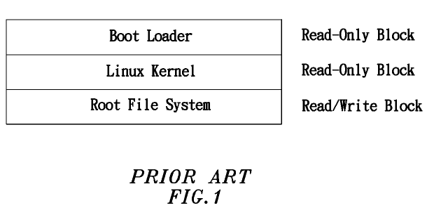

FIG. 2 is a specification table of a flash memory according to the present invention.

FIG. 3 is a flow chart of the processing made by a flash memory according to the present invention.

### DETAILED DESCRIPTION OF THE PREFERRED EMBODIMENTS

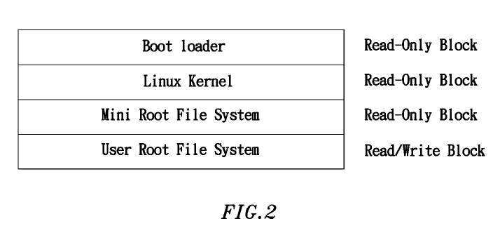

Referring to FIG. 2, the method for restoring a booted system is to divide a flash memory of a device into four blocks, and stores a boot loader, a Linux kernel, a mini root file system and a user root file system of an embedded Linux system into the separate blocks, and the blocks stored with the boot loader, the Linux kernel and the mini root file system are set as read-only blocks, and the block stored with the user root file system is set as a read/write block, so that users can write other application programs such as JFFS2, EXT2 and EXT3 into the user root file system, and adds a detect program to the mini root file system. When the device is booted, the detect program will be executed first to detect whether or not the user root file system is damaged. If the user root file system is not damaged, the user root file system is used as the embedded Linux system. On the contrary, if the user root file system is damaged, the mini root file system will be used as the embedded Linux system. Such arrangement allows other application programs to be written into the user root file system. If the user root file system is damaged, the mini root file system will be used for the booting, and then the user root file system will be repaired, so as to prevent the device from being unusable.

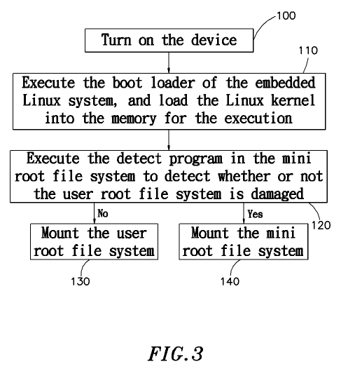

Refer to FIGS. 2 and 3, if the device is booted, the embedded Linux system will carry out the following steps:

(100) turning on the device;

(110) executing the boot loader in the embedded Linux system, and loading the Linux Kernel into the memory for the execution;

(120) executing the detect program in the mini root file system to detect whether or not the user root file system is damaged; if the detected user root file system is not damaged, then carry out step (130); and if the detected user root file system is damaged, then carry out step (140);

(130) using the user root file system to mount the system; and

(140) using the mini root file system to mount the system.

Even if the user root file system is damaged, the embedded Linux system still can use the mini root file system to mount the system. After the device is booted, the user root file system can be repaired so as to avoid the situation of unable to use the device as it does in the prior art.

Further, when the detect program detects whether or not the user root file system is damaged; the user root file system will be mounted to a subdirectory of the mini root file system, and confirms whether or not the mount is successful. If the mount is successful, the detect program will continuing to determine whether or not the user root file system mounted to the subdirectory of the mini root file system is damaged. If the user root file system is not damaged, then the detect program will continue to check whether or not the user root file system includes programs such as sbin/init, bin/bash, bin/sh, and etc/inittab. If the user root file system includes all the aforementioned programs, then the user root file system is not damaged. If any of the foregoing programs detected by the detect program is missing, then the user root file system is damaged.

The main characteristic of the method for restoring a booted system in accordance with the present invention resides on dividing a prior art root file system into a mini root file system and a user root file system, and storing the mini root file system and the user root file system in a read-only block and a read/write block respectively, and adding a detect program in the mini root file system, such that when the device is booted, the detect program will be executed first to detect whether or not the user root file system is damaged. If the user root file system is not damaged, the user root file system will be used as the embedded Linux system. If the user root file system is damaged, the mini root file system will be used as the embedded Linux system. Therefore, other application programs can be written in the user root file system. Even if the user root file system is damaged, the mini root file system can be used for booting, and thus avoiding the device from being unusable at all.

What is claimed is:

1. A method for restoring a booted system, dividing a flash memory in a device that uses an embedded Linux system into four blocks, and three of said four blocks are read-only blocks and one of said four blocks is a read/write block, and storing a boot loader, a Linux kernel and a mini root file system of said embedded Linux system into said each read-only block, and storing a user root file system into said read/write block, and said mini root file system includes a detect program capable of detecting whether or not said user root file system is damaged, wherein when said device is booted, said detect program will detect whether or not said user root file system is damaged first to determine to mount said user root file system or said mini root file system to said embedded Linux system.

2. The method for restoring a booted system as claimed in claim 1, wherein when said detect program determines that said user root file system is not damaged, then said user root file system will be mounted to said embedded Linux system.

3. The method for restoring a booted system as claimed in claim 1, wherein when said detect program determines that said user root file system is damaged, then said mini root file system will be mounted to said embedded Linux system.

4. A method for restoring a booted system, dividing a flash memory in a device using an embedded Linux system into four blocks, and three of said four blocks are read-only blocks and one of said four blocks is a read/write block, said each read-only block stores a boot loader, a Linux kernel, and a mini root file system of said embedded Linux system, and said read/write block stores a user root file system of said embedded Linux system, wherein when said device is booted, said device will carry out a procedure comprising the steps of:
(A) turning on said device;
(B) executing said boot loader of said embedded Linux system and loading said Linux kernel into said memory for execution;
(C) executing a detect program in said mini root file system to detect whether or not said user root file system is damaged; if said user root file system is not damaged, carry out step (D); and
(D) using said user root file system to mount said system.

5. The method for restoring a booted system as claimed in claim 4, wherein if said step (C) determines that said user root file is damaged, then carry out a step (E) of using said mini root file to mount a system.

6. The method for restoring a booted system as claimed in claim 4, wherein when said detect program detects whether or not said user root file system is damaged, said detect program mounts said user root file system to a subdirectory of said mini root file system first, and then confirms whether or not said mount is successful.

7. The method for restoring a booted system as claimed in claim 4, wherein when said detect program detects whether or not said user root file system is used, said detect program determines whether or not said user root file is damaged.

8. The method for restoring a booted system as claimed in claim 4, wherein when said detect program detects whether or not said user root file system is damaged, said detect program checks whether or not said user root file system includes sbin/init, bin/bash, bin/sh and etc/inittab programs.
